(19) United States
(12) Patent Application Publication
(10) Pub. No.: US 2026/0147697 A1
(43) Pub. Date: May 28, 2026

(54) Data Generation for End to End Testing

(71) Applicant: Live Oak Banking Company, Wilmington, NC (US)

(72) Inventors: Nicholas Clark, Greensboro, NC (US); Christopher Scofield, Raleigh, NC (US); Aaron Snipes, Durham, NC (US); Christopher Swift, Raleigh, NC (US)

(21) Appl. No.: 19/366,906

(22) Filed: Oct. 23, 2025

Related U.S. Application Data
(60) Provisional application No. 63/725,744, filed on Nov. 27, 2024.

(51) Int. Cl. G06F 11/3668

(52) U.S. Cl. CPC G06F 11/3688

(57) ABSTRACT

Systems and methods for data generation for end-to-end testing. The system can receive a configuration file including computing instructions associated with a first software component and a second software component. The method includes executing the computing instructions within the configuration file, wherein executing the computing instructions exports a first set of parameters associated with the first software component and a second set of parameters associated with the second software component. The method includes generating a test data object comprising test data, wherein the test data for the first software component is formatted differently than the second software component based on the first set of parameters and the second set of parameters. The method includes executing one or more tests to test the at least the first software component or the second software component using the test data.

### PRIORITY CLAIM

The present application claims the benefit of U.S. Non-Provisional Patent Application No. 63/725,744, having a filing date of Nov. 27, 2024. Applicant claims priority to and the benefit of each of such applications and incorporates all such applications herein by reference in its entirety.

### FIELD

The present disclosure generally relates to techniques for generating test data and orchestrating testing for a computing system.

### BACKGROUND

Testing of new computing systems or new features in existing computing systems can be conducted to ensure that the computing system functions as intended. For instance, test data may be used to test system functionality prior to making the computing system available for use.

### SUMMARY

Aspects and advantages of embodiments of the present disclosure will be set forth in part in the following description, or may be learned from the description, or may be learned through practice of the embodiments.

In an example aspect, the present disclosure provides an example computing system. The example computing system includes one or more processors and one or more non-transitory, computer readable medium storing instructions that are executable by the one or more processors to cause the computing system to perform operations. The example operations include receiving a configuration file including computing instructions associated with a first software component and a second software component. The example operations include executing the computing instructions within the configuration file. The example computing instructions include generating a test data object including test data, the test data indicative of generic data for testing the first software component and the second software component. The example computing instructions include exporting a first set of parameters and a second set of parameters to the first software component and the second software component respectively, wherein the first set of parameters and the second set of parameters are associated with formatted test data based on the test data. The example operations include executing one or more tests using the formatted test data to test the at least the first software component or the second software component.

In some implementations, the test data object is associated with one or more global variables.

In some implementations, the operations include concatenating the one or more global variables associated with the test data object to a first test data format or a second test data format according to the first set of parameters and the second set of parameters respectively.

In some implementations, the first test data format and the second test data format are associated with one or more data validation rules.

In some implementations, the operations further comprise generating, based on the test data, the formatted test data according to the first test data format and the second test data format.

In some implementations, executing the one or more tests includes providing the formatted test data to at least one of the first software component or the second software component.

In some implementations, the operations include generating one or more test reports across the first software component and the second software component.

In some implementations, the first software component and the second software component are associated with one or more client systems.

In some implementations, the test data includes synthetic data, the synthetic data generated by one or more functions or algorithms.

In another example aspect, the present disclosure provides an example computer-implemented method. The example computer-implemented method includes receiving a configuration file including computing instructions associated with a first software component and a second software component. The method includes executing the computing instructions within the configuration file, wherein executing the computing instructions. In the method, executing the computing instructions includes generating a test data object comprising test data, the test data indicative of generic data for testing the first software component and the second software component. In the method, executing the instructions includes exporting a first set of parameters and a second set of parameters to the first software component and the second software component respectively, wherein the first set of parameters and the second set of parameters are associated with formatted test data based on the test data. The method includes executing one or more tests using the formatted test data to test the at least the first software component or the second software component.

In some implementations, the test data object is associated with one or more global variables.

In some implementations, the method includes concatenating the one or more global variables associated with the test data object to a first test data format or a second test data format according to the first set of parameters and the second set of parameters respectively.

In some implementations, the first test data format and the second test data format are associated with one or more data validation rules.

In some implementations, the method includes generating, based on the test data, the formatted test data according to the first test data format and the second test data format.

In some implementations, executing the one or more tests includes providing the formatted test data to at least one of the first software component or the second software component.

In some implementations, the method includes generating one or more test reports across the first software component and the second software component.

In some implementations, the first software component and the second software component are associated with one or more client systems.

In some implementations, the test data comprises synthetic data, the synthetic data generated by one or more functions or algorithms.

In another example aspect, the present disclosure provides an example non-transitory computer-readable medium storing instructions that are executable to cause one or more processors to perform operations. The example operations include receiving a configuration file including computing instructions associated with a first software component and a second software component. The example operations include executing the computing instructions within the configuration file. The example computing instructions include generating a test data object including test data, the test data indicative of generic data for testing the first software component and the second software component. The example computing instructions include exporting a first set of parameters and a second set of parameters to the first software component and the second software component respectively, wherein the first set of parameters and the second set of parameters are associated with formatted test data based on the test data. The example operations include executing one or more tests using the formatted test data to test the at least the first software component or the second software component.

In some implementations, the test data object is associated with one or more global variables.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example data computing ecosystem according to example aspects of the present disclosure.

FIG. 2 depicts an example data flow pipeline according to example aspects of the present disclosure.

FIG. 3 depicts an example data orchestration engine architecture according to example aspects of the present disclosure.

FIG. 4 depicts an example flowchart diagram of an example method according to example aspects of the present disclosure.

FIG. 5 depicts an example computing ecosystem according to example aspects of the present disclosure.

### DETAILED DESCRIPTION

The present disclosure relates generally to a test data generation and orchestration engine. More particularly, the present disclosure relates to generating test data and orchestrating test scenarios across a plurality of disparate software components. For instance, a data orchestration engine may receive a configuration file associated with one or more software components. The configuration file can include a series of actions such as executable functions or computing instructions that when executed by the data orchestration engine generates a test data object that can be used to test a scenario such as a workflow across the software components. For example, the configuration file can include a software components or software component plug-ins that indicate expected data types, formats of data, data requirements, etc. expected using parameters output by the data orchestration engine. Accordingly, the data orchestration engine can generate a generic data object including generic test data and software components and software component plug-ins. The software components and software component plug-ins can use the parameters to generate formatted expected by the software components my mapping to global variables of the generic object or the generic object itself thereby enabling end to end testing from the same test dataset.

Centrally generating test data across a plurality of applications and software components can be prohibitively difficult due to the variance in configurations of the data formatting and validation required by each software component. Furthermore, performing end to end testing across a plurality of applications and software components can be a challenge due to the isolated computing environments within each of the software components and a lack of uniformity amongst the test data.

An organization that offers services to end users may interact with third parties to facilitate or improve service offerings. For example, the organization may integrate with a mobile payment platform to enable end users to more easily make payments. However, the organization and the mobile payment platform may include different data structures and different requirements for data. By way of example, an organization may require a first name and last name to create a user account, and the mobile payment platform may require a first name, last name, and social security number to create a user account. As such it may be difficult to generate a test object to test changes within an organization's software application in a scenario where a new account creation workflow needs to be tested across the application and the platform because the test dataset must also account for the different test data structure and requirements of the mobile payment platform. Ultimately, this can make it difficult or impossible to perform a root cause analysis (RCA) of any issues that arise during testing.

Accordingly, implementations of the present disclosure propose a data orchestration engine that can be utilized to generate a test data object which includes generic test data and allows respective software components and software component plug-ins to generate formatted test data based on the generic test data in a centralized manner. This can enable end to end testing across the software components.

For example, implementations of the present disclosure allow workflow or scenarios for testing to be modeled as a data object. By way of example, a computing system for a service provider can receive a configuration file that defines a plurality of software components or software component plug-ins. The software components can be clients for various third-party applications. The software component plug-ins can be software which generates a test client on behalf of the software component and maintains an ephemeral or persistent test connection. The software component plug-ins can allow for reusability of the associated test client.

The configuration file can define a series of executable functions or computing instructions (e.g., actions) that, when executed by the computing system, cause the computing system to export parameters defining the location (e.g., path, etc.) of a generic data object. A generic data object is a data structure used for storing and interacting with data in a software application. The generic data object can provide access to the data stored therein to the software components defined in the configuration file. In an embodiment, the software components and/or software plug-ins can define a data object that models a workflow defined by the actions. For instance, data objects such as java script object notation (JSON) objects can be parameterized to initialize a function (e.g., workflow, scenario, etc.)

The data orchestration engine can iteratively execute the actions associated with each of the software components defined in the configuration file and export the respective parameters. Once the parameters have been exported, the data orchestration engine can utilize one or more computing functions or algorithms within a data generator to generate test (e.g., seed) data. Seed data can include synthetic or fake data used for testing. In an embodiment, the data generator can generate generic test data stored in a generic test object. In another embodiment, the data generator can generate test data that is formatted according to the parameters associated with each of the software components. The data orchestration engine can execute a mapping function to map the generic test data or the formatted test data to global variable associated with the generic data object such that the respective software components can access the formatted test data during testing.

By way of example, the computing system can receive a configuration file that defines a first software component and a second software component. The first software component can be an application client that offers a line of credit to end users, and the second software component can be an application client that performs credit check services used in the determination to approve the line of credit. The first and second software components defined in the configuration file can each include a series of computing instructions that when executed by the computing system cause the computing system to generate one or more generic data objects (e.g., credit line object).

For instance, the first software component may require that an end user provide financial information such as annual wages, debt obligations, and employer information. The financial information may additionally be associated with data validation rules. Data validation rules can include rules that constrain the values and format of data accepted by the software component. In an example, the first software component may require that annual wages and debt obligations include only integers excluding decimals. The second software component may also require that an end user provides financial information but additionally requires personal identifying information such as a social security number. Additionally, the second software component may be associated with data validation rules that are different than the first software component such as and require decimals within the annual wages and debt obligations.

The computing system can execute the computing instructions associated with the first software component and the second software component and export a first set of parameters associated with the first software component and a second set of parameters associated with the second software component. The first and second set of parameters can define a path location within the generic data object where respective fields or the data object itself are located. In an embodiment, the software component specific requirements of the first and second software components can be embedded into a wrapper call to the data generator causing the data generator to generated formatted test data based on the generic test data. In another embodiment, the first and second software components can query the data object based on the parameters and return generic test data which is formatted by the first and second software components respectively.

The data orchestration engine can generate a generic data object that includes global variables associated with the first and second software components. For instance, the generic data object can include a generic user data object that includes global variables such as name, address, contact information, financial information, etc. A global variable can include a variable or attribute of the generic data object that is visible across the software components defined in the configuration file.

The data orchestration engine can utilize the data generator to generate generic (e.g., fake, synthetic, etc.) test data and the data orchestration engine can execute a mapping function to concatenate the generic test data and/or formatted test data to respective global variables. For instance, the data generator can generate test financial data associated with the first and second software components. The generic user data object can store test generic test annual wages and debt obligations (e.g., generated by the data generator). The data orchestrator can execute a mapping function to concatenate the location (e.g., within the data object) of the generic test annual wages and debt obligations with a location within the software components and/or software component plug-ins based on the parameter.

The data orchestration engine can perform an action (e.g., wrapper call) that formats the generic test annual wages and debt obligations to a first data format that includes only integers excluding decimals as required by the first software component. A wrapper call can include a set of programming instructions or code that acts as an intermediary layer between an application and an API allowing more complex API calls to be made. Similarly, the data orchestration engine can perform an action (e.g., wrapper call) to format the generic test annual wages and debt obligations to a second data format expected by the second software component. The formatted test annual wages and debt obligations for the first and second software components can be stored in a test computing environment during an end-to-end test.

In an embodiment, the computing system can provide the test data to a testing pipeline such as continuous integration/continuous delivery (CI/CD) pipeline. For instance, the computing system can load the test data into a test computing environment and initiate a test scenario. An example test scenario may include a test workflow where a test user provides the requisite information to the first software component and facilitates a test credit line application by interacting with the second software component to acquire test credit details to provide a test response. The computing system can generate a test report for the test scenario across the first and second software components.

While examples herein describe testing implementations in the context of a financial application, the present disclosure is not limited to such embodiment and may be implemented in any computing ecosystem which requires testing across disparate computing systems. It should also be noted that implementations described herein discuss the collection and utilization of various types of data.

Any mention of data associated with users, as described herein, can be securely stored and protected against any type of unauthorized use or access. In addition, sensitive information, such as user data, is collected only with the express permission of said users. Users are provided the option to opt-out, or otherwise opt-in, to collection of such data.

Aspects of the present disclosure provide a number of technical effects and benefits. As one example technical effect and benefit, implementations of the present disclosure can substantially reduce the time required for engineering teams to test software changes, thus creating efficiency gains and substantially reducing compute resources necessary to generate seed data independently for each computing system. For example, using conventional techniques, test data may need to be created and formatted for each software component and testing may occur only within the respective system due to varying data formatting requirements. However, by centrally generating test data and formatting the same test data to accommodate the various requirements of the disparate computing systems, the present disclosure can efficiently tailor test data, eliminating the need to generate redundant test data and thus substantially reducing compute resources utilized to generate multiple sets of test data (e.g., power, memory, storage, compute cycles, etc.).

As another example of technical effect and benefit, implementations of the present disclosure can substantially reduce utilization of compute resources for determining the RCA for issues that arise during testing. Specifically, the test report can provide visibility across all software components due to the mapping function that concatenates test data across the software components with global variables. Engineering teams can quickly isolate data formatting or data structure requirements as the cause of issues that occur during testing. By only reducing the surface area of types of testing errors, implementations of the present disclosure can substantially reduce bandwidth utilization, computing, and storage resource utilization needed to store different test data and repetitively test scenarios.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations may be made to the embodiments without departing from the scope of the present disclosure. For instance, features illustrated or described as part of one embodiment may be used with another embodiment to yield a still further embodiment. Thus, it is intended that aspects of the present disclosure cover such modifications and variations.

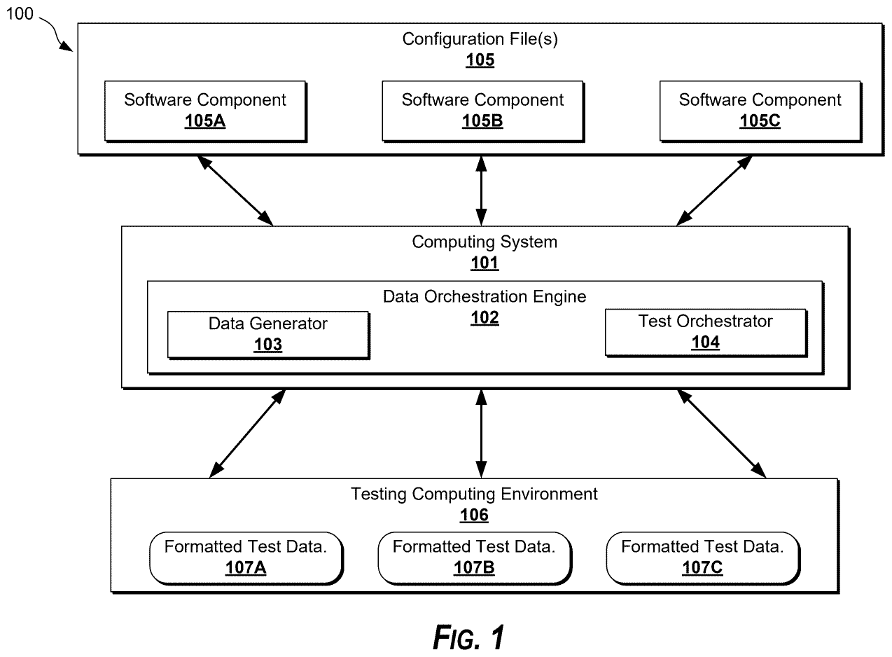

FIG. 1 depicts an example computing ecosystem according to example aspects of the present disclosure. The following description of computing ecosystem 100 is described within an example implementation in which a data orchestration engine 102 running on a computing system 101 receives one or more configuration files 105 associated with software components 105A-C and utilizes a data generator 103 to generate a generic data object and generic test data. The software components 105A-C can access the generic data object and generic data and request formatted test data 107A-C compatible with respective software components 105A-C by initializing actions by the data orchestration engine. Once the formatted test data 107A-C has been generated, a test orchestrator 104 can orchestrate end to end testing across the software components 105A-C using the formatted test data 107A-C and a testing computing environment 106.

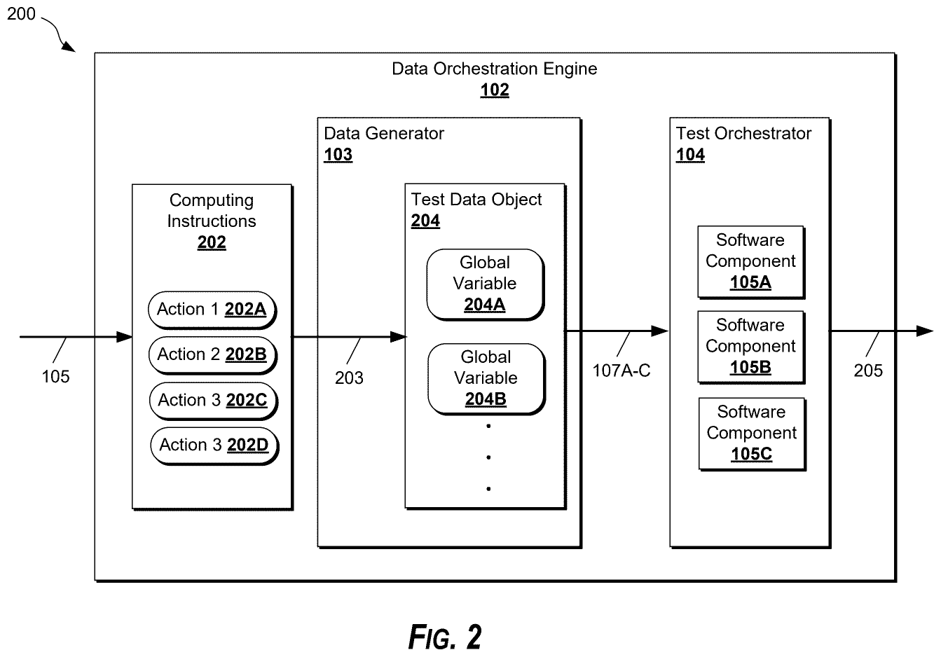

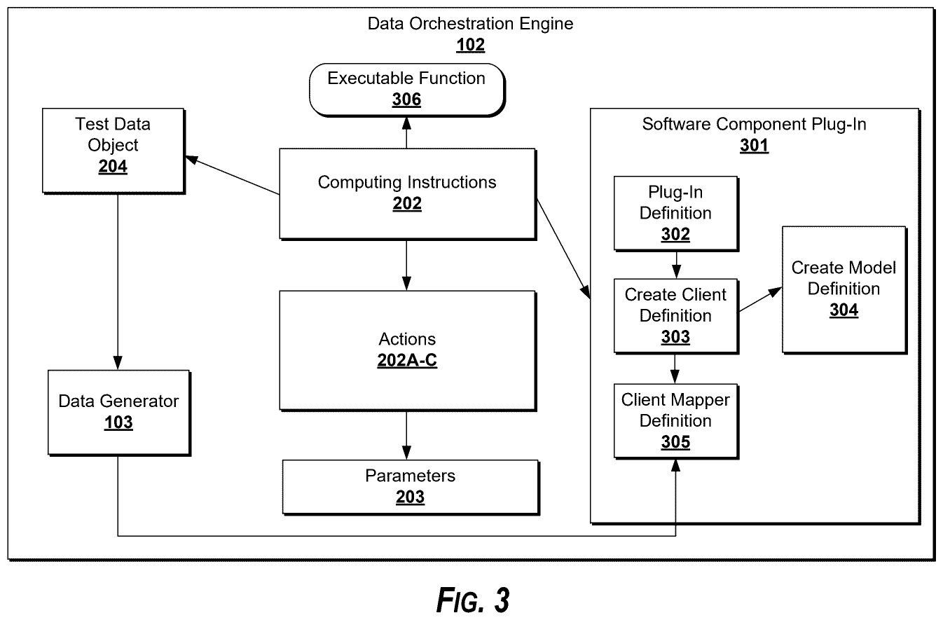

The configuration files 105 can include software computing instructions such as a script or an interpreted software program that are executable by the data orchestration engine 102 running on the computing system 101. The configuration files 105 can include computing instructions (e.g., functions, methods, routines, subroutines, subprogram, procedures, etc.) that, when executed, cause the data orchestration engine 102 to perform operations (e.g., actions). Actions are further described with reference to FIGS. 2-3.

For example, the configuration file 105 can include computing instructions that define a test scenario or workflow that includes one or more software components 105A-C. The software components 105A-C can include clients within a client-server relationship with the computing system 101 that provide back-end services or extend the functionality of the computing system 101. By way of example, the computing system 101 may be associated with a financial service provider that is responsible for offering and facilitating financial services or products to users. The computing system 101 may utilize one or more software components 105A-C (e.g., back-end services) for offering services or products. The services may be provided by third-party clients or disparate systems and include, for example, financial loans, investment accounts, financial advisement, etc.

In an embodiment, one or more software components 105A-C or the computing system 101 may undergo a change such as a software update, new feature release, etc. For instance, a change to a back end workflow that enables end users of the computing system 101 to apply for a new financial service may be included as a change that impacts a “new application” workflow. The new application workflow may impact the computing system 101 and the software components 105A-C. The configuration file 105 may include computing instructions (e.g., actions) that define the software components 105A-C (e.g., clients) involved in the new application workflow.

Computing instructions that define the software components 105A-C can include computing instructions that when executed initiate communications with the respective software component 105A-C. For instance, the computing instructions may include an API call that calls the respective software component 105A-C. In an embodiment, the computing instructions may initiate communications with a sub-production environment of the respective software component 105A-C to allow for testing without impacting the production system.

The software components 105A-C can include clients for separate computing systems that maintain different data structures, require different data validation, or different data formatting. The configuration file 105 can include computing instructions that when executed (e.g., API call, etc.) provide the respective data requirements for each of the software components 105A-C. By way of example, the computing instructions may include an API call that causes a response to be returned from the software component 105A-C that indicate the data structure (e.g., JSON, etc.) utilized by the software component 105A-C. For instance, data structure can be associated with a set of parameters that can be exported that indicate the location and structure of data of each of the software components 105A-C. In an embodiment, the parameters can be used to map the various data requirements of each of the software components 105A-C. For instance, the data format requirements can be associated with one or more global variables. An example of global variables is further described with reference to FIG. 2.

The configuration file 105 can include computing instructions that, when executed, cause the data orchestration engine 102 to generate a generic data object that stores data needed by the computing system 101 and the software components 105A-C to test the scenario or workflow. For instance, the generic data object can include a data structure that stores generic data expected by each of the software components 105A-C during testing.

In an embodiment, the configuration file 105 can define one or more test scripts or test scenarios that test the functionality of the scenario or workflow using test data generated within the data orchestration engine 102. For example, the configuration file, once executed, can initiate testing of the software components 105A-C and the computing system 101.

The computing system 101 may include a cloud-based server system. For example, the computing system 101 may include one or more servers within a client-server relationship with the software components 105A-C, testing computing environment 106, etc., allowing for interactions with the computing system 101. By way of example, the computing system 101 may host or otherwise include one or more APIs for communicating data to/from the computing system 101 to/from the software components 105A-C, various third-parties, or other external entities.

The computing system 101 may include one or more computing devices. For instance, the computing system 101 may include a control circuit and a non-transitory computer-readable medium (e.g., memory). The control circuit of the computing system 101 may be configured to perform the various operations and functions described herein. A further description of the computing hardware and components of computing system 101 is provided herein with reference to other figures.

The computing system 101 may include one or more subsystems. For instance, the computing system 101 may include a data orchestration engine 102. The data orchestration engine 102 may include software running on one or more servers of the computing system 101. The data orchestration engine 102 may be configured to execute the computing instructions contained in configuration files 105 and in response to executing the computing instructions generate a generic data object that includes one or more global variables. An example of the data generator 103 generating a test data object associated with global variables is further described with reference to FIG. 2.

The data orchestration engine 102 can include one or more subsystems. For instance, the data orchestration engine 102 can include a data generator 103 for generating synthetic (e.g., fake data) and a test orchestrator 104 for facilitating testing of the software components 105A-C. The data generator 103 may include software running or one or more servers of the data orchestration engine 102. In an embodiment, the data generator 103 may be a standalone component or software module that interfaces with the data orchestration engine 102. For instance, the data generator can be a microservice called (e.g., API call, etc.) by the data orchestration engine 102.

The data generator 103 can be configured to generate synthetic (e.g., fake) test data using a computing function or algorithm. Examples of computing functions or algorithms to generate fake data may include “faker-js”, “falso”, or any other data generator that can generate unauthentic data. In some embodiments, the data generator 103 can generate test data. The test data can be used to test a scenario of workflow that involves one or more software components 105A-C. In some embodiments, the software components 105A-C may cause the data generator 103 to generate formatted test data 107A-C using a wrapper call. The wrapper call can include a set of programming instructions or code that acts as an intermediary layer between an application and an API allowing more complex API calls to be made.

By way of example, the computing system 101 can receive the configuration file 105 defining software components 105A-C associated with the new application workflow. The data orchestration engine can execute a portion of the computing instructions associated with each of the software components 105A-C and generate a data object. A subsequent action can include exporting one or more parameters that indicate the location of the data object, fields, global variables, etc. The parameters can be used to concatenate the location of the generic object with locations within the software components 105A-C where definitions for each of the software components 105A-C and define the data structure, formatting, validation, etc., that is acceptable by each of the software components 105A-C are defined.

In an embodiment, the parameters can be exported from the output of an action (e.g., data orchestration engine output) and used as input into the data generator 103. For instance, the data generator 103 can be configured to generate synthetic or fake test data for each of the software components 105A-C defined in the configuration file 105. The synthetic or fake test can be formatted (e.g., formatted test data 107A-C) for each of the software components 105A-C defined in the configuration file 105 using a wrapper call or formatted by the software components 105A-C independently.

The data orchestration engine 102 can include a test orchestrator 104. The test orchestrator 104 can include software running on one or more servers of the data orchestration engine 102. In an embodiment the test orchestrator 104 can include a standalone component or software module that interfaces with the data orchestration engine 102. For example, the test orchestrator 104 can include an independent testing service that is called (e.g., API call etc.) by the data orchestration engine 102.

The test orchestrator 104 can be configured to create and test software projects. For instance, the test orchestrator 104 can include a platform or plug-in that automates continuous integration/continuous delivery (CI/CD) testing workflows or pipelines. Example CI/CD platforms may include, but are not limited to GitLab, GitHub Actions, Jenkins, etc.

Once the data orchestration engine 102 has executed the computing instructions included in the configuration file 105, the data generator 103 can generate formatted test data 107A-C and test orchestrator 104 can initiate testing of the scenario or workflow in the testing computing environment 106.

By way of example, the data orchestration engine 102 can execute computing instructions defined in the configuration file 105 that cause the test orchestrator to provision a test computing environment 106. A test computing environment 106 can include one or more servers or computing resources suitable to perform one or more workflow tests. For instance, the testing computing environment 106 can include a non-production computing environment in parity with the computing system 101 such that execution of a simulated (e.g., test) workflow will generate test reports similar to a workflow execution within the computing system 101. While examples herein describe a scripted test workflow, the present disclosure is not limited to such embodiment and may be initiated independently or on a different cadence than described. For instance, individual software components 105A-C may be tested individually, concurrently, sequentially, etc., and may be initiated by remote computing systems or manually.

Once the test computing environment 106 has been provisioned, the test orchestrator 104 can initiate one or more testing pipelines. The testing pipelines can include a script or series of computer functions that simulate the test workflow. By way of example, the test orchestrator 104 can initiate a new application testing pipeline that simulates the new application workflow. The test orchestrator 104 can expose the data object storing the formatted test data 107A-C to test versions of the software components 10A-C running in the test computing environment. For instance, the formatted test data 107A-C can be associated with global variables that allow the software components to access the formatted test data 107A-C from the data object during testing.

The test orchestrator 104 can execute the new application testing pipeline and generate one or more test reports indicating the outcome of the new application workflow. For example, the new application testing pipeline can include a first step of providing demographic information of a test user to a first software component 105A by querying the generic data object to obtain formatted test data 107A that includes a fake first name, last name, address, etc. formatted to the requirements of the first software component 105A. In another example, the new application testing pipeline can include a second step of calling a second software component 105B to provide the demographic information and financial information. For instance, the second software component 105B may be associated with an integration platform that can retrieve financial information from a plurality of sources. Accordingly, the second software component 105B can receive formatted test data 107B that includes the same demographic information as second software component 105B and financial information that is formatted to the requirements of the second software component 105B.

Once testing has been completed, the one or more test reports generated can indicate points of success or failures across each of the software components 105A-C. For instance, the formatted test data 107A-C that is used throughout the test workflow can be used to trace issues and determine the root cause of issues that arose during testing. In an embodiment, the one or more test reports can be transmitted to a system custodian or developer responsible for managing testing within the computing system 101 or the respective software component 105A-C.

FIG. 2 depicts an example data flow pipeline according to example aspects of the present disclosure. The following description of dataflow pipeline 200 is described within an example implementation in which the data orchestration engine 102 receives a configuration file 105 and executes a plurality of actions 202A-D defined by the computing instructions 202. The plurality of actions 202A-D can include generating a test data object 204 and utilizing the data generator 103 to populate the test data object 204 with test data that is associated with global variables 204A-B. The test data object 204 can be exposed to the test orchestrator 104 and accessed by the software components 105A-C during testing. For instance, the test orchestrator 104 can output 205 one or more computing instructions to initiate testing of a workflow or scenario that involves the software components 105A-C.

The action 202A-D can include executed software commands or functions performed by the data orchestration engine 102. For instance, the computing instructions 202, once executed perform action 202A-D to generate the test data object, export parameters 203 associated with the software components 105A-C, generate formatted test data 107A-C, and map the formatted test data 107A-C according to the parameters 203 and the global variables 204A-B. The global variables 204A-B can include an attribute of the test data object 204 that is accessible across the software components 105A-C defined in the configuration file 105.

By way of example, the data orchestration engine 102 can receive a configuration file 105 that includes computing instructions 202 associated with a first software component 105A and a second software component 105B involved in a payment transaction workflow. Based on the computing instructions 202, the data orchestration engine 102 can determine a payment test data object will be utilized to perform testing across the first software component 105A and the second software component 105B. For instance, the data orchestration engine 102 can execute the computing instructions 202 within the configuration file 105 and perform a series of actions associated with the first software component 105A and the second software component 105B.

An action 202A-D can include communicating with the first software component 105A and the second software component 105B to determine the test data object 204 to be created and export a parameters 203 indicating the path or location of the test data object 204. For instance, a first set of parameters associated with the first software component 105A and a second set of parameters associated with the second software component 105B can be determined once the test data object 204 has been generated.

In some embodiments, the first and second software components 105A-B may each store payment objects (e.g., configured to the payment API endpoint) to facilitate the payment workflow. For instance, the payment objects may include the same structure (e.g., fields, data validation, etc.) across the first and second software components 105A-B. In some embodiments, the payment objects may include a different structure such as different fields across the first and second software components 105A-B. By initiating generating a generic data object with global variables 204A-B, the first and second software components can utilize the data orchestration engine 102 generate or retrieve formatted test data 107A-C that includes the specific data format structure and validation requirements specific to the respective software components 105A-B.

In an embodiment, the first and second set of parameters can include the data structure and formatting requirements associated with the first software component 105A and the second software component 105B respectively. For instance, the parameters can be passed into a wrapper call to the data generator 103 where the generic test data for the test data object 204 can be formatted to generate the formatted test data 107A-C and transmitted to the first software components 105A-C using the global variables as a reference. The global variables 204A-B can contain a numeric value, a string, or an indexed array of strings. For example, the global variables 204A-B may contain an array of strings, which specify an action (e.g., formatting action, retrieving action, etc.). In an embodiment, the global variables may use an entire array, a particular index, or all the values starting at a particular index. An array and index are further described with reference to FIG. 3.

By way of example, global variables 204A-B may be associated with the payment test data object that can be determined based on the computing instructions 202. For instance, the configuration file 105 may include hardcoded global variables 204A-B or hardcoded formatted test data 107A-C that is explicitly defined and populated upon creation of the test data object 204. In another embodiment, the global variables 204A-B can be determined based on the exported parameters 203. For instance, the data orchestration engine 102 can analyze the exported parameters and determine respective fields, etc., that will be referenced by the first software component 105A and the second software component 105B during testing and generate a global variable 204A-B that is accessible for these fields, values, etc. across the first software component 105A and the second software component 105B.

An action 202A-D can include utilize the data generator 103 to generate test data for the first and second software components 105A-B. For example, the data generator 103 can pass through the parameters 203 (e.g., via a wrapper call) to customize output of the test (e.g., fake) data that is formatted to the specifications of the first and second software components 105A-B.

By way of example, the first set of parameters can include the location or path from a date field of the test data object 204 to a date field associated with the first software component 105A. The date field associated with the first software component 105A may include a validation rule which requires that test (e.g., fake) data include data on or after Jan. 1, 2020, to prevent downstream issues. The second set of parameters may include can include the location or path from a date field of the test data object 204 to a date field associated with the second software component 105B. The date field associated with the second software component 105B may include a validation rule which requires that test data include a date format of a two digit day, two digit month, and a four digit year. The first and second set of parameters can be passed via a wrapper call to the data generator 103 to cause the data generator 103 to generate formatted test data 107A-B based on the generic test data, where the formatted test data 107A-B is compatible with the first and second software components 105A-B.

An action 202A-D can include mapping the formatted test data 107A-B to respective global variables 204A-B. For instance, the software components 105A-C can include a mapper locations and paths from the test data object 204, global variables 204A-B, etc. data locations associated with the software components 105A-B.

By way of example, the date may be a global variable 204A associated with the payment test data object. The global variable 204A may be defined by the computing instructions 202. The first software component 105A can access the generic test data object 204 or generic test data to facilitate generation of formatted test data 107A including the formatted date value by referencing the global variable 204A.

Once the data orchestration engine has parsed the configuration file 105, executed each of the computing instructions 202, and performed all defined action 202A-DA-D, the data orchestration engine 102 can initiate the test orchestrator 104 to facilitate a test payment workflow or scenario. For instance, the test orchestrator 104 can access the test data object 204 and expose the test data object 204 including the global variables 204A-B to a test computing environment 106. In an embodiment the test orchestrator 104 can output 205 one or more computing instructions to initiate testing of a workflow or scenario that involves the software components 105A-C.

FIG. 3 depicts an example data orchestration engine architecture according to example aspects of the present disclosure. The example architecture 300 can be implemented within the computing system 101 to expose an execute function for executing the computing instructions 202 and programmatically generating formatted test data 107A-C for testing. The architecture 300 depicts elements and steps performed in a particular order for purposes of illustration and discussion. Those of ordinary skill in the art, using the disclosures provided herein, will understand that the elements of any of the architecture 300 discussed herein can be adapted, rearranged, expanded, omitted, combined, or modified in various ways without deviating from the scope of the present disclosure.

The example architecture 300 can include the data orchestration engine 102 and one or more software component plug-ins 301. The data orchestration engine 102 can include a starting index for an array 306 which exposes an execute function or command as the first action to a test client associated with the software component plug-in 301. The test client can be a client associated with a respective software component 105A-C as described herein. The data orchestration engine 102 can receive the computing instructions 202 and parse out action 202A-D into the array 306, global variables 204A-B associated with the test data object 204, and respective software component plug-ins 301.

For instance, the computing instructions 202 can include instructions for a software component plug-in 301. A software component plug-in 301 can include a reusable test client 302 (e.g., associated with a software component 105A-C) that is accessible to the data orchestration engine 102 and allows for subsequent testing scenarios to be facilitated. In an embodiment, the software component plug-ins 301 can be included within the codebase of the data orchestration engine 102. An example test client 302 can include but is not limited to an Axios® client. For instance, an Axios® client can include an isomorphic (e.g., able to run in a browser and in the data orchestration engine 102) promise-based HTTP client which simplifies the process of making HTTP requests (e.g., API calls) from the data orchestration engine 102 to the respective servers (e.g., associated with the third-party software component 107A-C). While examples herein describe an Axios® type client, the present disclosure is not limited to such embodiment and may be any type of application client.

The test client 302 can include a software tool configured to test web server operations such as testing a new workflow or scenario using the respective software component 105A-B. The test client 302 can be defined for new software component plug-ins 301 and referenced or called by the computing instructions 202 for existing software component plug-ins 301. The test client 302 can make API calls to the data orchestration engine 102 to facilitate the generation and export of test data or formatted test data 107A-C. For instance, the test client 302 can invoke the data generator 103 and receive test data or formatted test data 107A-C associated with a test data object 204. In some implementations, the test client 302 can invoke the data generator 103 and receive formatted test data 107A-C. The test data (e.g., or formatted test data 107A-C) can be used for a workflow or scenario test using the software component 105A-C associated with the software component plug-in 301.

The software component plug-in 301 can include a client model definition 303 that models a test workflow or scenario (e.g., defined by the computing instructions 202) as a test data object 204. A client definition model 303 can include computing instructions 202 which operate to model a scripted workflow or scenarios into a data object (e.g., test data object 204). The client definition model 303 can include computing instructions 202 that run on the test client 302. Action 202A-D can be defined by the software component plug-in 301 and passed into the array 306 for execution by the data orchestration engine 102 to generate test data (e.g., or formatted test data 107A-C) needed to perform the steps of the workflow in the test computing environment 106. For example, the software component plug-in 301 can include a client model definition 303 that models an account opening workflow as a JSON object. The JSON object can be defined by the client model definition 303 and the software component plug-in 301 can define a series of action 202A-D which generate the test data (e.g., formatted test data 107A-C) needed to test the account opening scenario.

By way of example, data orchestration engine 102 can execute computing instructions 202 to import an array of action 202A-D defined by the software component plug-in 301 using the client definition model 303. The client definition model 303 can concatenate actions 202A-D and data objects or global variables 107A-C using a key which identifies the computing function. For instance, the client model definition 303 can include a client model action 304 input at runtime where, the software component plug-in 301 can provide inputs, the client instance identifier (e.g., test client id), imports, or other data to the data orchestration engine 102 to define the action 202A-D to be performed.

For example, the action 202A-D can include a series of string values along with the computing function that define the action 202A-D against the test data object 204. For instance, an action 202A-D can include a string value that identifies the software component plug-in 301, a string value that identifies the test data object 204, a string value that identifies the type of action (e.g., create, etc.), and an array of string value that represent the global variables 104A-B that will be leveraged during execution of the action 202A-D. The string values can be included in the action 202A-D passed to the array 306 for execution.

In an example, an account opening workflow may involve a first software component 105A and a second software component 105B. The computing instructions 202 can define (e.g., script, etc.) a test data object 204 including global variables 107A-C that will be used in the workflow or steps included in opening an account. The data orchestration engine 102 can first call or define the software component plug-ins 301 associated with the first and second software components 105A-B respectively. Each of the software component plug-ins 301 can include a model definition 303 that defines the one or more generic account test data objects (e.g., test data object 204) and the one or more global variables 204A-B. For instance, the software component plug-ins 301 may reference the global variables 204A-B that are accessible across the first and second software components 105A-B when exporting test data or formatted test data 107A-C during a test run.

The data orchestration engine 102 can iterate through each of the action 202A-D associated with the software plug-ins 301 and generate one or more test data objects associated with the workflow or scenario. One action 202A-D can include exporting one or more parameters 203 to the software component plug-ins 301 which indicate one or more keys that identify the generated test data objects 204. In some embodiments, the parameters 203 may indicate a path to the test data object 204 where test data or formatted test data 107A-C may be located to allow the software component plug-ins 301 (e.g., test client) to generate API calls to access the created test data.

By way of example, the test data object 204 can include a generic account object which includes generic (e.g., unformatted test data) account information that may be used during an account opening workflow. For instance, one action 202A-D may include causing the data generator 103 to generate synthetic test data to populate the account test data object. The test data generated by the data generator 103 may be associated with global variables 204A-B to enable access to the software plug-ins 301. The parameters 203 exported to the software component plug-ins 301 may be passed into the calls to the data generator 103 (e.g., from the test client) to retrieve the generated test data. To do so, the test data object 204 and global variables 204A-B may be mapped to data objects utilized by the software component plug-ins 301.

For example, the test data object 204 can include a global object with an associated mapper function to concatenate the test data object 204 with one or more software component plug-ins 301 data objects. As previously described, software component 105A-C can include independent data structures and data objects to facilitate interactions with other computing processes or systems. The client mapper definition 305 of the software component plug-in 301 can include a key or signature that defines a mapper type as an object or a global variable 107A-C.

The key or signature can be used to concatenate global objects (e.g., objects accessible to all software plug-ins 301) or global variables 204A-B based on the exported parameters that identify the location of specific test data object 204, global variables 207A-C, etc. In this manner, the client mapper definition 305 within the software component plug-ins 301 can be used to link the test data object 204, fields, etc. with data objects (e.g., data storage locations) used by the software components 105A-C. Accordingly, test data generated by the data generator 103 via one or more action 202A-D (e.g., wrapper calls) can be transmitted or otherwise made accessible to the software components 105A-C using the software component plug-ins 301.

In some embodiments, the parameters 203 may also include formatting requirements/instructions to generate the format test data 107A-C. For instance, the action 202A-D to export the mapped generic test data from the test data object 204 may include one or more functions to generate formatted test data 107A-C. By way of example, the action may export parameters 203 indicating account test data object which includes an account password field. Based on the parameters 203 indicating the concatenated account object used by the first software component 105A including a data validation rule of alphanumerical passwords, the action 202A-D may include a function to convert the account password to the expected alphanumerical format for the first software component 105A.

In some embodiment, the software component plug-in 301 may include logic to convert generic test data or generic test data objects 204 into formatted test data 107A-B. By way of example, the action 202A-D may export, based on the parameters 203 generic test data associated with the account test data object to the software component plug-in 301. The client model action 304 may take in the generic test data or generic account test data object as input and return an output to the test client 302 that includes the formatted test data 107A-C. For instance, the software component plug-in 301 may generate the formatted test data 107A-C based on the generic test data generated by the data generator 103.

In this manner, the architecture 300 may simplify the logic of the data orchestration engine 102 by only generating generic test data objects 204 and generic data. This enables the software component plug-ins 301 to facilitate the generation of formatted test data 107A-C which satisfies the respective specifications of the software components 105A-C while using the same generic test data objects 204. Furthermore, the plug-in architecture enables reusability due to the relative stability of mapped data objects and global variables 107A-C.

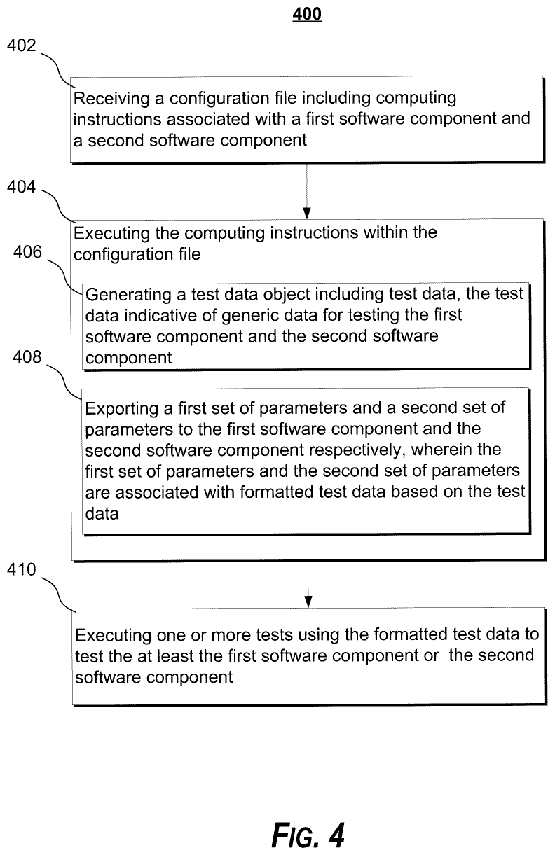

FIG. 4 depicts a flowchart diagram of an example method according to example aspects of the present disclosure. One or more portion(s) of the method 400 may be implemented by one or more computing devices such as, for example, the computing devices/systems described in FIGS. 1, 2, 3, etc. Moreover, one or more portion(s) of the method 400 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 400. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 400 may include a step 402 or otherwise begin by receiving a configuration file comprising computing instructions associated with a first software component and a second software component. For instance, the data orchestration engine 102 may receive a configuration file 105 that includes computing instructions 202 defining one or more software components 105A-C. By way of example, a first and second software component 105A-B may be associated with a fund transfer scenario or workflow. The first software component 105A may be associated with an original account and the second software component 105B can be associated with a destination account. The first and second software components 105A-C may be used in a testing scenario to test a fund transfer workflow using generated test data within a testing computing environment 106.

In an embodiment, the method 400 may include a step 404 or otherwise continue by executing the computing instructions within the configuration file. For instance, the data orchestration engine 102 can include a starting index for an array 306 which exposes an execute function or command as the first action. The data orchestration engine 102 can receive the computing instructions 202 and execute computing instructions 202 to perform a plurality of actions 202A-D.

In an embodiment, the step 404 may include a sub-step 406 or otherwise continue by, generating a test data object comprising test data, the test data indicative of generic data for testing the first software component and the second software component. For instance, computing instructions 202 can include an action 202A-DA that when executed by the data orchestration engine 102 causes the data generator 103 to generate a test data object 204. The test data object 204 can be a generic data object associated with the fund transfer workflow. By way of example, the test data object 204 may be a generic payment object that stores payment information such as routing numbers, account numbers, financial institutions, etc. The first software component 105A and the second software component 105B may each interact with a respective payment object to facilitate the fund transfer workflow.

In an embodiment, the step 404 may include a sub-step 408 or otherwise continue by exporting a first set of parameters and a second set of parameters to the first software component and the second software component respectively, wherein the first set of parameters and the second set of parameters are associated with formatted test data based on the test data. For instance, an action 202A-D can include exporting respective parameters 203 to the first software component 105A and the second software component 105B which indicate one or more keys that identify the generated test data objects 204. In some embodiments, the parameters 203 may indicate a path to the test data object 204 where test data or formatted test data 107A-B may be located to enable access to the first and second software components 105A-B.

By way of example, the first and second set of parameters may be exposed to the first and second software components 105A-B and the first and second software components 105A-B may utilize the parameters 203 to retrieve formatted test data 107A-B. For instance, the parameters 203 may be passed to the data generator 103 as a wrapper call to generate formatted test data 107A-B based on the generic payment data object. In an embodiment, the parameters 203 can be utilized by the first and second software components 105A-B to retrieve data from the test data object 204 (e.g., payment object) and converted to formatted test data 107A-B based on the test data object 204.

In an embodiment, the method 400 may include a step 410 or otherwise continue by executing one or more tests using the formatted test data to test the at least the first software component or the second software component. For instance, the test computing environment 106 can be provisioned and the test orchestrator 104 can initiate one or more testing pipelines. The testing pipelines can include a script or series of computer functions that simulate the test fund transfer workflow using the formatted test data 107A-B for the first and second software components 105A-B.

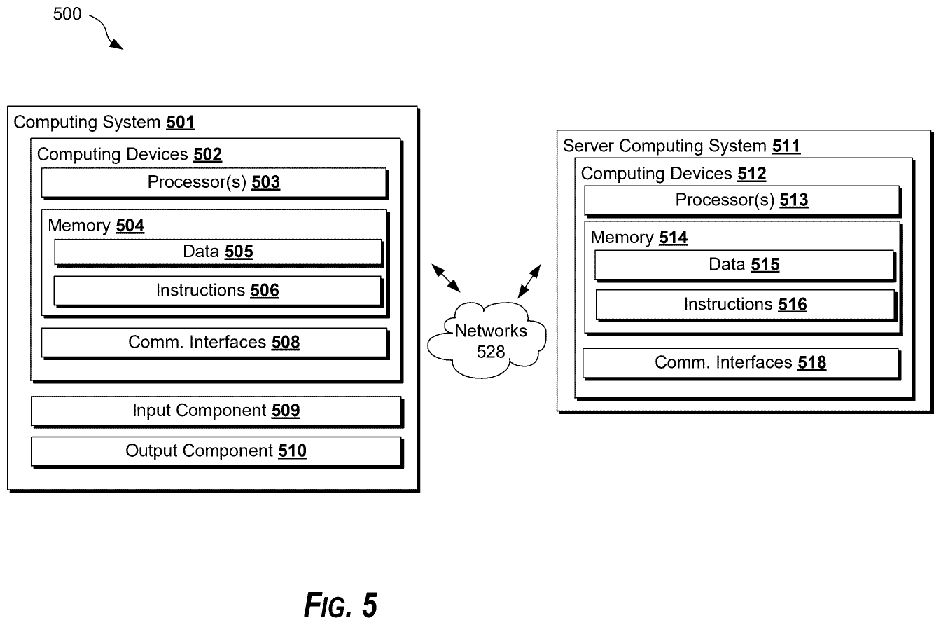

FIG. 5 depicts a block diagram of an example system 500 for implementing systems and methods according to example embodiments of the present disclosure. The system 500 includes a computing system 501 (e.g., computing system 101) and a server computing system 511 communicatively coupled over one or more networks 528.

The computing system 501 may include one or more computing devices 502 or circuitry. For instance, the computing system 501 may include one or more processors 503 and a memory 504. In an embodiment, the processors 503 may be any suitable processing device (e.g., a processor core, a microprocessor, an ASIC, a FPGA, a controller, a microcontroller, etc.) and may be one processor or a plurality of processors that are operatively connected. The memory 504 may include one or more non-transitory computer-readable storage media, such as RAM, ROM, EEPROM, EPROM, one or more memory devices, flash memory devices, etc., and combinations thereof.

The memory 504 may store information that may be accessed by the processors 603. For instance, the memory 504 (e.g., memory devices) may store data 505 that may be obtained, received, accessed, written, manipulated, created, and/or stored. The data 505 may include, for instance, any of the data or information described herein. In some implementations, the computing system 501 may obtain data from one or more memories that are remote from the computing system 501.

The memory 504 may also store computer-readable instructions 606 that may be executed by the processor(s) 503. The instructions 506 may be software written in any suitable programming language or may be implemented in hardware.

The instructions 506 may be executed in logically and/or virtually separate threads on the processor(s) 503. For example, the memory 504 may store instructions 506 that when executed by the processor(s) 503 cause the processor(s) 503 to perform any of the operations, methods and/or processes described herein. In some cases, the memory 504 may store computer-executable instructions or computer-readable instructions, such as instructions to perform at least a portion of the method of FIG. 4.

The computing system 501 may include one or more communication interfaces 508. The communication interfaces 508 may be used to communicate with one or more other systems. The communication interfaces 508 may include any circuits, components, software, etc. for communicating via one or more networks (e.g., networks 528). In some implementations, the communication interfaces 508 may include for example, one or more of a communications controller, receiver, transceiver, transmitter, port, conductors, software and/or hardware for communicating data/information.

The computing system 501 may also include one or more user input components 509 that receives user input. For example, the user input component 509 may be a touch-sensitive component (e.g., a touch-sensitive user interface of a mobile device) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 501 may include one or more output components 510. The output components 510 may include hardware and/or software for audibly or visually producing content. For instance, the output components 510 may include one or more speakers, earpieces, headsets, handsets, etc. The output components 510 may include a display device, which may include hardware for displaying a user interface and/or messages for a user. By way of example, the output component 510 may include a display screen, CRT, LCD, plasma screen, touch screen, TV, projector, tablet, and/or other suitable display components.

The server computing system 511 may include one or more computing devices 512. In an embodiment, the server computing system 511 may include or is otherwise implemented by one or more server computing devices. In instances in which the server computing system 511 includes plural server computing devices, such server computing devices may operate according to sequential computing architectures, parallel computing architectures, or some combination thereof.

The server computing system 511 may include a processor(s) 513 and a memory 514, also referred to herein as memory 514. In an embodiment, the processors 513 may be any suitable processing device (e.g., a processor core, a microprocessor, an ASIC, a FPGA, a controller, a microcontroller, etc.) and may be one processor or a plurality of processors that are operatively connected. The memory 514 may include one or more non-transitory computer-readable storage media, such as RAM, ROM, EEPROM, EPROM, one or more memory devices, flash memory devices, etc., and combinations thereof. In an embodiment, the memory 514 may be a memory device, also referred to as a data storage device, which may include an electronic storage device, a magnetic storage device, an optical storage device, an electromagnetic storage device, a semiconductor storage device, or any suitable combination thereof. The memory may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The memory 514 may store information that may be accessed by the processor(s) 1013. For instance, the memory 514 (e.g., memory devices) may store data 515 that may be obtained, received, accessed, written, manipulated, created, and/or stored. The data 515 may include, for instance, any of the data or information described herein. In some implementations, the server computing system 511 may obtain data from one or more memories that are remote from the server computing system 511.

The memory 514 may also store computer-readable instructions 516 that may be executed by the processor(s) 513. The instructions 516 may be software written in any suitable programming language or may be implemented in hardware. The instructions may include computer-readable instructions, computer-executable instructions, etc.

The instructions 516 may be executed in logically and/or virtually separate threads on the processor(s) 513. For example, the memory 514 may store instructions 516 that when executed by the processor(s) 513 cause the processor(s) 513 to perform any of the operations, methods and/or processes described herein. In some cases, the memory 514 may store computer-executable instructions or computer-readable instructions, such as instructions to perform at least a portion of the methods of FIG. 4.

The server computing system 511 may include one or more communication interfaces 1018. The communication interfaces 518 may be used to communicate with one or more other systems. The communication interfaces 518 may include any circuits, components, software, etc. for communicating via one or more networks (e.g., networks 528). In some implementations, the communication interfaces 518 may include for example, one or more of a communications controller, receiver, transceiver, transmitter, port, conductors, software and/or hardware for communicating data/information.

The one or more networks 628 may be any type of communications network, such as a local area network (e.g., intranet), wide area network (e.g., Internet), or some combination thereof and may include any number of wired or wireless links. In general, communication over a network 628 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5 illustrates one example computing system that may be used to implement the present disclosure. Other computing systems may be used as well. For example, in an embodiment, the computing system 501 may include the server computing system 511 and the data 515.

Computing tasks discussed herein as being performed at certain computing device(s)/systems may instead be performed at another computing device/system, or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein may be adapted, rearranged, expanded, omitted, combined, or modified in various ways without deviating from the scope of the present disclosure. Some implementations are described with a reference numeral for example illustrated purposes and are not meant to be limiting.

What is claimed is:

1. A computing system comprising:
one or more processors; and
one or more non-transitory computer-readable media storing instructions that are executable by the one or more processors to cause the computing system to perform operations, the operations comprising:
receiving a configuration file comprising computing instructions associated with a first software component and a second software component;
executing the computing instructions within the configuration file, wherein executing the computing instructions comprises:
generating a test data object comprising test data, the test data indicative of generic data for testing the first software component and the second software component; and
exporting a first set of parameters and a second set of parameters to the first software component and the second software component respectively, wherein the first set of parameters and the second set of parameters are associated with formatted test data based on the test data; and
executing one or more tests using the formatted test data to test the at least the first software component or the second software component.

2. The computing system of claim 1, wherein the test data object is associated with one or more global variables.

3. The computing system of claim 2, wherein the operations further comprise:
concatenating the one or more global variables associated with the test data object to a first test data format or a second test data format according to the first set of parameters and the second set of parameters respectively.

4. The computing system of claim 3, wherein the first test data format and the second test data format are associated with one or more data validation rules.

5. The computing system of claim 3, wherein the operations further comprise:
generating, based on the test data, the formatted test data according to the first test data format and the second test data format.

6. The computing system of claim 1, wherein executing the one or more tests comprises providing the formatted test data to at least one of the first software component or the second software component.

7. The computing system of claim 1, wherein the operations further comprise:
generating one or more test reports across the first software component and the second software component.

8. The computing system of claim 1, wherein the first software component and the second software component are associated with one or more client systems.

9. The computing system of claim 1, wherein the test data comprises synthetic data, the synthetic data generated by one or more functions or algorithms.

10. A computer-implemented method comprising:
receiving a configuration file comprising computing instructions associated with a first software component and a second software component;
executing the computing instructions within the configuration file, wherein executing the computing instructions comprises:
generating a test data object comprising test data, the test data indicative of generic data for testing the first software component and the second software component; and
exporting a first set of parameters and a second set of parameters to the first software component and the second software component respectively, wherein the first set of parameters and the second set of parameters are associated with formatted test data based on the test data; and
executing one or more tests using the formatted test data to test the at least the first software component or the second software component.

11. The computer-implemented method of claim 10, wherein the test data object is associated with one or more global variables.

12. The computer-implemented method of claim 11, further comprising:
concatenating the one or more global variables associated with the test data object to a first test data format or a second test data format according to the first set of parameters and the second set of parameters respectively.

13. The computer-implemented method of claim 12, wherein the first test data format and the second test data format are associated with one or more data validation rules.

14. The computer-implemented method of claim 12, further comprising:
generating, based on the test data, the formatted test data according to the first test data format and the second test data format.

15. The computer-implemented method of claim 10, wherein executing the one or more tests comprises providing the formatted test data to at least one of the first software component or the second software component.

16. The computer-implemented method of claim 10, further comprising:
generating one or more test reports across the first software component and the second software component.

17. The computer-implemented method of claim 10, wherein the first software component and the second software component are associated with one or more client systems.

18. The computer-implemented method of claim 10, wherein the test data comprises synthetic data, the synthetic data generated by one or more functions or algorithms.

19. A non-transitory computer-readable media storing instructions that are executable by one or more processors to perform operations, the operations comprising:
receiving a configuration file comprising computing instructions associated with a first software component and a second software component;
executing the computing instructions within the configuration file, wherein executing the computing instructions comprises:
generating a test data object comprising test data, the test data indicative of generic data for testing the first software component and the second software component; and
exporting a first set of parameters and a second set of parameters to the first software component and the second software component respectively, wherein the first set of parameters and the second set of parameters are associated with formatted test data based on the test data; and
executing one or more tests using the formatted test data to test the at least the first software component or the second software component.

20. The non-transitory computer-readable media of claim 19, wherein the test data object is associated with one or more global variables.
